(19) United States
(12) Patent Application Publication
(10) Pub. No.: US 2005/0135964 A1
(43) Pub. Date: Jun. 23, 2005

(54) Carrier medium for analyzing a substance

(76) Inventor: Ulrich Sieben, Vorstetten (DE)

Correspondence Address: Samuels, Gauthier & Stevens LLP, Suite 3300, 225 Franklin Street, Boston, MA, 02110, US

(21) Appl. No.: 10/743,263

(22) Filed: Dec. 22, 2003

(51) Int. Cl. G01N 31/22

(52) U.S. Cl. 422/57

(57) ABSTRACT

The invention relates to a carrier medium (10, 20, 30, 30′) for analyzing an analyte, to which biological and/or chemical substances (A through I) are applied in at least two defined regions (11, 21, 31, 31′), with a code (12, 32, 3′) showing which biological and/or chemical substance (A through I) is located in which of the defined regions (11, 21, 31, 31′). The invention also relates to a method for manufacturing carrier media with the following steps:
a. producing a set of identical carrier media (30) having a first arrangement of the defined regions (31) and/or a first arrangement of the biological and/or chemical substances (A through I) within the defined regions (31),
b. assigning a different code (32) to each of these carrier media (30),
c. storing the arrangement of the defined regions (31) and/or the arrangement of the biological and/or chemical substances (A through I) within the defined regions (31) of the carrier media (30) along with the associated code (32),
d. selecting a second arrangement of the defined regions (31), and/or of the biological and/or chemical substances (A through I) in the defined regions (31), that is different from the first arrangement, e. implementing steps a through c for the second arrangement, f. implementing steps a through c for subsequent arrangements different from the arrangements already used.

### DESCRIPTION

The invention relates to a carrier medium for analyzing an analyte. In addition, the method relates to a method for producing such carrier media, as well as a device and a method for reading such carrier media.

Carrier media are known which are used for the purpose of testing an analyte in regard to a specific condition. To this end, a biological or chemical substance is applied to the carrier medium, the substance either reacting or not reacting upon contact with the substance depending on the condition. As a rule, the reaction is manifested by a color change in the carrier medium. Known carrier media include, for example, those which, when they come in contact with a liquid, change color in response to the pH of the liquid; or carrier media which upon contact with urine indicate whether a pregnancy is present. Carrier media coated with an antibody are able to verify through a color reaction whether or not the associated viruses are present in the blood of a patient.

The disadvantage of carrier media of this type is the fact that an analyte may be tested only for a single condition. If a number of analyses is to be made on the analyte, a time-consuming and costly analysis at a physician's office is required, and a large quantity of the analyte such as blood or urine is required.

The goal of the invention is therefore to provide a carrier medium which is suitable f or multiple analyses, thereby offering a method of analysis to the patient that is both convenient and also saves time and expense.

Implicit in a carrier medium of this type is the fact that smaller quantities of biological or chemical substance are required. It is thus the goal of the invention to provide a method for producing and reading these carrier media, which media are nevertheless commercially profitable for the producer of the biological and/or chemical substances. The goal of the invention is thus to provide a method for reading the carrier media which allows for a cost-effective accounting of the reading. Another goal of the invention consists in providing a device for reading the carrier media according to the invention, which device is capable of reading the carrier media in terms of the method according to the invention.

The goal of the invention is achieved by a carrier medium for analyzing an analyte according to claim 1, a method for producing carrier media according to claim 12, a device for reading a carrier medium according to claim 19, and a method for reading carrier media according to claim 24.

In at least two defined regions, biological and/or chemical substances are applied to the carrier medium according to the invention for analyzing an analyte, which carrier medium is additionally provided with a code indicating which biological and/or chemical substance is located in which defined region. The application of multiple biological and/or chemical substances to one carrier medium enables multiple analyses to be performed simultaneously on the analyte. This approach reduces the required quantities of the biological and/or chemical substance. The carrier medium itself does not reveal which biological and/or chemical substance is located in which region; this information is provided only by the code which indicates which substance is located in which region.

Preferably, several hundred biological and/or chemical substances are applied in a corresponding number of defined regions. As a result, several hundred analyses may be performed simultaneously on an analyte such as blood or urine, thereby saving considerable time and expense.

Preferably, the biological and/or chemical substances are arranged differently within the defined regions on two different carrier media. As a result, it is not possible to draw conclusions from the arrangement of the biological and/or chemical substances on one carrier medium about the corresponding arrangement of biological and/or chemical substances on a second carrier medium. It is only by reading the code on the carrier medium that it is possible to determine which biological and/or chemical substance is located in which region.

Preferably, the defined regions are arranged differently on two different carrier media. As a result, it is not possible to draw conclusions from the arrangement of the defined regions on one carrier medium about the arrangement of the defined regions on a second carrier medium. In particular, this design for the carrier medium provides an additional means of encoding.

Preferably, a temperature sensor for detecting ambient temperature is provided on the carrier medium in order to record any improper storage of the carrier media at excessively high or low temperatures.

In an advantageous embodiment of the invention, the code is a barcode, a numerical code, or an alphanumeric code, or the code is provided by the arrangement of the defined regions on the carrier medium. This last implementation variant for the code, in particular, is preferred since no space is provided on the carrier medium for a barcode, so that instead the code is indicated by the arrangement of the defined regions.

Preferably, the code provides information to a device reading the carrier medium as to how the device should read which regions. For example, if certain biological and/or chemical substances respond in a completely different wavelength region than other biological and/or chemical substances, the code may contain this information and instruct the reading device to set specific detectors for the reading in accordance with the expected wavelengths to be detected.

Preferably, the code contains information about the expiration date of the carrier medium. After specific storage periods, certain biological and/or chemical substances react to form different substances and, as a result, may no longer be used for the designated analyses. The code is able to pass on the appropriate information to a device reading carrier media such that a corresponding warning may be issued by the reading device in the event a carrier medium is used after the expiration date.

In an advantageous embodiment of the invention, the code of the carrier medium contains information about the storage of the carrier medium from the time of manufacture to the time the carrier medium was used. Certain biological and/or chemical substances must not be stored above or below specific temperatures, as otherwise certain undesirable reactions occur. The carrier medium preferably contains means for detecting the ambient temperature whereby in the event certain temperatures are exceeded, either on the high side or low side, these variations are stored in the code. If such a carrier medium is nonetheless used for an analysis, the reading device is able to detect based on the code that the carrier medium has not been stored according to specification and issue a warning to this effect.

The carrier medium is advantageously composed of a film strip, glass carrier, or paper.

Preferably, the biological and/or chemical substances used are DNA, RNA, proteins, or antibodies. As a result, analyses may be performed focusing on bacteria or viruses.

The method according to the invention for producing the carrier media comprises the following steps:
a. producing a set of identical carrier media having a first arrangement of the defined regions and/or a first arrangement of the biological and/or chemical substances within the defined regions,
b. assigning a different code to each of these carrier media,
c. storing the arrangement of the defined regions and/or the arrangement of the biological and/or chemical substances within the defined regions of the carrier media along with the associated codes,
d. selecting a second arrangement of the defined regions, and/or of the biological and/or chemical substances in the defined regions, that is different from the first arrangement,
e. implementing steps a through c for the second arrangement,
f. implementing steps a through c for subsequent arrangements different from the arrangements already used.

This production method ensures that each individual carrier medium produced receives a different code, and that the code is stored along with the associated arrangement of defined regions or with the arrangement of biological and/or chemical substances in the defined regions. While a certain number of carrier media are thus produced which have an identical arrangement of defined regions, or of biological and/or chemical substances in the defined regions, nevertheless these carrier media are differentiated by their corresponding codes, with the result that no two carrier media identical in every respect are produced, and when two carrier media are compared it is impossible to detect which biological and/or chemical substance is located in which defined region.

Preferably, the code is provided by a simple numbering of the carriers. A code of this type is the simplest means of providing the different carrier media with different codes.

Preferably, the biological and/or chemical substances are printed on the defined regions of the carrier media with a print head analogous to that used in an inkjet printing process. As a result, the carrier media may be produced in a particularly inexpensive manner, while the defined regions are able to be locally placed with high precision on the carrier media.

Preferably, one set consists of approximately 1,000 to 10,000 carrier media. Several hundred sets are advantageously produced. As a result, a large number of carrier media are produced whereby the carrier media are present in different forms.

One type of carrier medium each is advantageously selected from the various sets, and these selected carrier media are packaged together. One pack thus contains only carrier media with different arrangements and, as a result, it is impossible to draw conclusions from the arrangement on one carrier medium about the arrangement of a second carrier medium. Since ideally the various packs are distributed throughout a given country, or are even distributed worldwide, the probability that a given user would receive carrier media having identical arrangements (although with different codes) is extremely low.

Alternatively, multiple sets of carrier media are mixed and randomly selected for inclusion in a common pack. In this approach, the possibility cannot be excluded that two carrier media with identical arrangements are included in one pack, although the probability of this occurring is relatively low given a sufficient number of sets.

The device according to the invention for reading a carrier medium according to the invention has at least one optical detector per defined region, with the optical detectors detecting the reactions of the biological and/or chemical substances in the defined regions as soon as the control device has been brought into a read position relative to the device.

Preferably, the device has means for acquiring and transmitting the code to an administrative center. The device itself is not able to determine the arrangement of the read carrier medium from the code since the arrangement of the defined regions, and/or arrangement of biological and/or chemical substances within the defined regions, along with the associated codes, are not stored within the reading device. It is therefore necessary to transmit the code to an administrative center in which the specific arrangement corresponding to the extracted code is determined. The device itself is only able to detect in which defined region a reaction of the biological and/or chemical substances has occurred in response to the analyte; it is not, however, able to indicate which biological and/or chemical substance has reacted.

The optical detectors of the device are preferably semiconductor chips.

Means for digitizing the detected signals and/or transmitting the detected signals to the administrative center are preferably provided in the device so that the detected signals are able to undergo subsequent processing in an optimal manner.

The method according to the invention for reading a carrier medium according to the invention in conjunction with the use of a device for reading the carrier medium according to the invention comprises the following steps:
a. applying the analyte to the carrier medium,
b. moving the carrier medium into the read position relative to the device for reading the carrier medium,
c. transmitting the code of the carrier medium to an administrative center,
d. within the administrative center, evaluating the code and determining the associated arrangement.

The advantage of the method according to the invention for reading a carrier medium lies in the fact that it provides the manufacturers of the carrier media or biological and/or chemical substances, and/or the medical insurance company, with a profitable accounting system. The application of several hundred different biological and/or chemical substances onto a carrier medium means that significantly smaller quantities of these substances are required. The quantities required here may be reduced by a factor of between 10⁶ and 10⁹. A new accounting system is nevertheless needed in order to ensure that the production of these biological and/or chemical substances remains profitable.

The fact that such carrier media are produced in relatively large quantities, since they provide a simple test for certain diseases, bacteria or viruses, and are thus used frequently by people, does not compensate for the loss generated by the smaller required quantities. For this reason, the method according to the invention leaves evaluation of the carrier media to a central administrative center. Although the inventive design of the carrier media and of the device for reading a carrier medium does enable a person to detect reactions of the biological and/or chemical substances to the analyte, this person himself is not able to correlate the detected signals with specific biological and/or chemical substances; instead, in order to accomplish this, the code must be transmitted from the device for reading a carrier medium to the administrative center at which the arrangement associated with the code is determined. While the person is thus able to determine whether or not a positive reaction of the analyte to some kind of biological and/or chemical substance has occurred, it is not possible for this person to determine which biological and/or chemical substance is involved. In order to cover the cost of production for the carrier media, or of the biological and/or chemical substances, the cost of determining a given arrangement associated with a code may, for example, be accounted for in the administrative center.

Preferably, however, the evaluation of the code and determination of the associated arrangement within the administrative center are performed at no cost, then a fee is charged only in the event an analyte has reacted positively to the biological and/or chemical substances. This approach provides a health service which may be implemented in a cost-effective and time-saving manner for the individual but which is also acceptable to the medical insurance companies and the overall healthcare system. The cost-effective availability of the carrier media enables an individual, for example, to test his blood or urine on a regular basis for reactions to certain biological and/or chemical substances, whereby a fee is incurred only in the event a reaction has occurred, that is, in the event the specific person is ill in some way. The relevant fee or partial fee may, for example, be passed on by the administrative center to the medical insurance companies.

The administrative center preferably transmits instructions to the reading device as to how the optical detectors are to be set for the specific defined regions. This measure ensures an optimal read-out of the carrier medium.

In step e, the reactions of the defined regions are preferably detected with the optical detectors adjusted to their optimal setting.

In step f, the detected signals are advantageously transmitted to the administrative center.

In step g, the arrangement of the biological and/or chemical substances of the carrier medium, and/or the evaluation of the detected signals are transmitted from the administrative center [to]* the device for reading.

In an alternative reading method, the reactions of the defined regions are first detected by the optical detectors of the reading device after step b, and then the detected signals
*Word added by translator. are also transmitted to the administrative center in step c. The steps related to transmitting the instructions to the reading device are thus eliminated, although here the first reading of the carrier medium is, as a result, not performed with the optical detectors adjusted to their optimal setting.

In step e, the arrangement of the biological and/or chemical substances of the carrier medium and/or the evaluation of the detected signals are preferably transmitted from the administrative center to the reading device.

In an advantageous modification of the method according to the invention, requests are sent by the administrative center to set certain defined regions in accordance with the detected signals in order to increase the accuracy of measurement and reduce the probability of error.

Preferably, a request is sent by the administrative center, in response to certain detected signals, to read another carrier medium having additional biological and/or chemical substances different from the biological and/or chemical substances on the first carrier medium after application of the analyte. In this way, additional tests may be performed in the case of a reaction to a given biological and/or chemical substance possibly indicating the presence of a certain disease.

The detected signals and the code for the transmission from the reading device to the administrative center are preferably encrypted with a public key. This measure offers additional security for the data transfer while also providing to the administrative center a means for decrypting the data.

The transmission of the detected signal and code to the administrative center are preferably error-protection-coded. This measure provides a higher level of security for the data transfer.

The following discussion explains the invention in more detailed based on the figures.

FIG. 1 shows a first embodiment of a carrier medium;

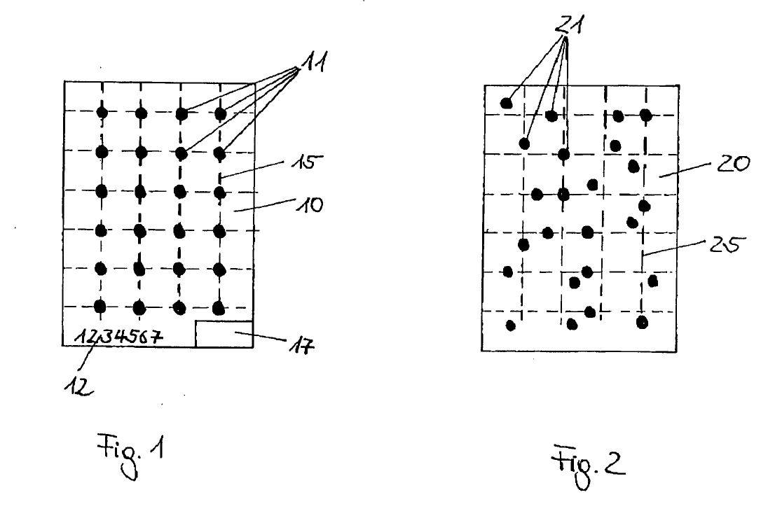

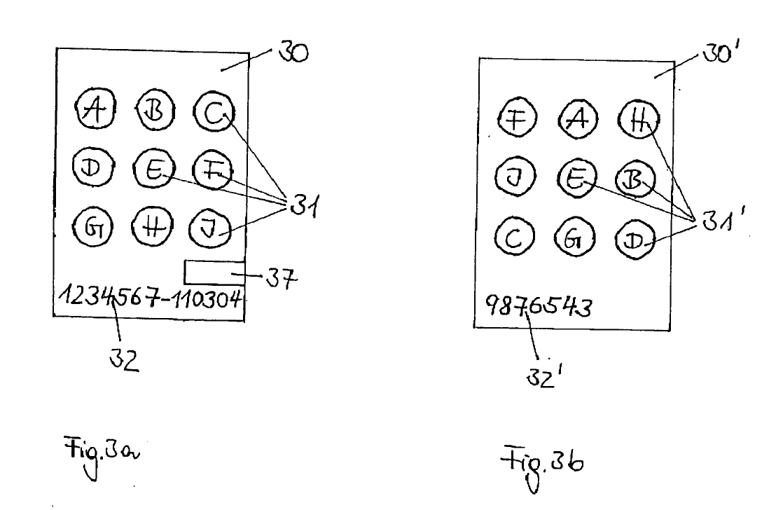

FIG. 2 shows a second embodiment of a carrier medium;

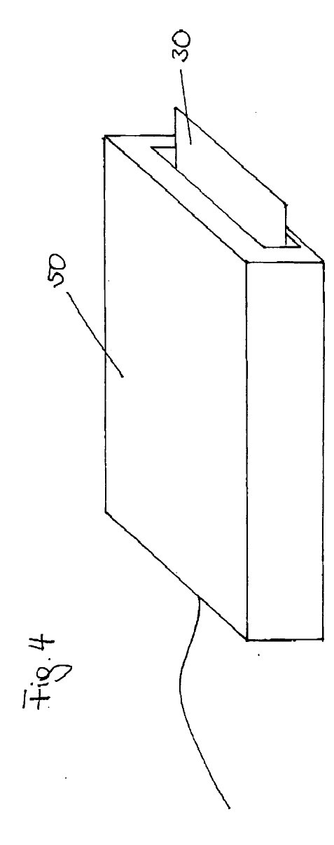

FIG. 3a shows a third embodiment of a carrier medium;

FIG. 3b shows a carrier medium corresponding to the carrier medium of FIG. 3a;

FIG. 4 is a perspective view of a device for reading a carrier medium.

FIG. 1 shows an embodiment of a carrier medium 10 according to the invention. Carrier medium 10 is essentially composed of a rectangular film strip on which defined regions 11 are aligned on an essentially square grid 15. Carrier medium 10 is approximately the size of a check card. A code 12 is located on one narrow end of carrier medium 10, the code being in the form of a numerical code. Code 12 here may be located at any desired site on the carrier medium. A barcode or alphanumeric code may also be used in place of the numerical code. Biological and/or chemical substances are applied within the defined regions of carrier medium 10, whereby each of the individual defined regions 111 contains a different biological and/or chemical substance. Preferably, several hundred defined regions 11 are located on carrier medium 10 such that the naked eye is not able to detect defined regions 11. The naked eye is thus unable to recognize which biological and/or chemical substance has been applied to which defined region 11. Code 12 provides the information as to which substance is located in which region. This information is not, however, directly accessible to the user of carrier medium 10.

Carrier medium 10 has a temperature sensor 17. This sensor records the ambient temperature of carrier medium 10. Certain biological and/or chemical substances must only be stored at certain temperatures. In the event a maximum temperature or minimum temperature has been exceeded, the biological and/or chemical substances react to form different substances, and are thus no longer usable for the desired test. The information as to whether or not the specified temperature range has been maintained is accessible from the temperature sensor 17 and may be retrieved by the device for reading the carrier medium 50.

FIG. 2 shows another embodiment of a carrier medium 20 according to the invention. Carrier medium 20 is also composed of an essentially rectangular film strip on which biological and/or chemical substances have been applied within the defined regions 21 of the film strip. Unlike the embodiment of FIG. 1, defined regions 21 here are not all precisely aligned in an essentially square grid 25. Some of defined regions 21 are located precisely at the intersection points of grid 25, whereas other defined regions 21 deviate, either horizontally or vertically, from the positions provided by grid 25. Biological and/or chemical substances are arranged within defined regions 21; however, due to the large number of several hundred, regions 21 are of correspondingly small size so that the naked eye is unable to detect which biological and/or chemical substance is located in which of the defined regions 21. The pattern created by the deviations of defined regions 21 from the intersection points of grid 25 represent a code indicating which biological and/or chemical substance is located in which of the defined regions 21.

In a method according to the invention for producing the carrier media, not all the carrier media are of identical form. FIGS. 3a and 3b show two carrier media 30 and 30′ from the same production process. In the method according to the invention, a set of identical carrier media is first produced with a first arrangement of biological and/or chemical substances in defined regions 31. Defined regions 31 are arranged in an essentially rectangular grid. The biological and/or chemical substances are designated by capital letters A through I. A different biological and/or chemical substance is thus located in each of defined regions 31. Carrier media 31 are also equipped with a temperature sensor 37.

For the sake of illustrative simplification, carrier medium 30 has only nine defined regions 31. However, carrier medium 30 according to the invention has, for example, 500 defined regions which are arranged in a grid defined by a 25×20 matrix.

In the first set of carrier media, this arrangement of the biological and/or chemical substances is identical. However, all the carrier media 30 in the first set of carrier media are distinguished by a code 32 which is imprinted on one of the narrower ends of carrier medium 30. For example, if code 32 is a seven-digit number, a maximum of one million carrier media 30 could be produced with the first arrangement of biological and/or chemical substances such that each carrier medium 30 has a different code. In the present example, the first set of carrier media 30 is designed to comprise 10,000 media which are numbered by numerical codes 1 through 10,000. Information is stored in the administrative center indicating that carrier media 30 with codes 1 through 10,000 have the first arrangement of biological and/or chemical substances.

In a second set of carrier media 30′, the arrangement of biological and/or chemical substances has been modified. The biological and/or chemical substance A, which in the first set of carrier media 30 in defined region 31 is located at the top left, is now located within defined region 31′ at the center of the top line. The position of the subsequent biological and/or chemical substances B-I has also been modified. This arrangement of biological and/or chemical substances within defined regions 31′ is identical for all carrier media 30′ of the second set of carrier media. Carrier media 30′ of the second set of carrier media are similarly distinguished by a code 32′ which is imprinted on one of the narrower ends of carrier medium 30′. Here codes 32′ are used for the second set of carrier media 30′, which codes are different from codes 32′ of the first set of carrier media 30′. For example, the second set of carrier media 30′ also have 10,000 media which are numbered with codes 10,001 through 20,000.

Each carrier medium thus receives a different code, although multiple carrier media may have an identical arrangement of biological and/or chemical substances within the defined regions. Each carrier medium produced is therefore different. The number of possible different carrier media is determined by the number of biological and/or chemical substances on the carrier medium and by the maximum number of different codes. If a carrier medium has 500 different biological and/or chemical substances, the result is 500! different arrangements for the biological and/or chemical substances, whereby in the case of a seven-digit numerical code one million different codes may be provided for each arrangement.

In order to ensure that, after the production of, for example, 200 sets of carrier media with the same arrangement, only carrier media having different arrangements of biological and/or chemical substances are contained in one pack, 100 sets are randomly selected from the 200 sets, and from these 100 sets one carrier medium each is selected, after which the carrier media thus selected are packed in one pack. The selection of the sets and carrier media is implemented using a random number generator.

Use of the carrier media according to the invention consists in applying an analyte, for example the blood or urine of a patient, to the surface of the carrier medium. Biological and/or chemical substances which may be used include DNA, RNA, proteins, and antibodies. If the analyte contains the corresponding “counterpart” to the biological and/or chemical substance, a reaction takes place which is generally manifested as a change in color of the corresponding defined region. The color changes may, for example, lie in the visible region of the spectrum, or they may also lie within the infrared or ultraviolet regions. Given that there are several hundred defined regions on one carrier medium the size of an ATM card*, it is not possible for the naked eye to detect the reactions of the analyte with the biological and/or chemical substances, and carrier medium 30 is therefore placed, after application of the analyte, into a device 50 for reading the carrier medium. To this end, device 50 has a drive system, analogous to a disk drive, in which carrier medium 30 is moved into the read position relative to device 50 (see FIG. 4). Once carrier medium 30 is in the read position, optical detectors, for example semiconductor chips, are located above the individual defined regions 31, which detectors detect the color changes of defined regions 31. However, device 50 is not capable of assigning the detected signals to the biological and/or chemical substances A through I applied to defined regions 31. For this purpose, a means must be attached to device 50 which reads code 32 of carrier medium 30 and transmits it to the administrative center.
*German Scheckkarte=ATM card. With the client's permission, we would like to change this to “credit card” which is the same size, and eliminates the distraction to the reader of decoding “ATM” which, in context, might be thought to be a chemical or electronic term. Translator.

In a first method, the detected signals for defined regions 31 are transmitted along with code 32. The assignment relating code 32 to the arrangement of biological and/or chemical substances A through I within defined regions 31 of different carrier media 30, 30′ is stored in the administrative center. It is thus the administrative center that determines for which biological and/or chemical substances A through I a reaction has taken place with the analyte. The administrative center sends the result back to device 50 and, depending on the situation, indicates whether additional carrier media, such as those with different biological and/or chemical substances, are to be analyzed. For example, if on the initially analyzed carrier medium a positive reaction has been found for a certain biological and/or chemical substance, it may be appropriate to analyze the analyte for additional biological and/or chemical substances which were not present on the first carrier medium. In addition, the administrative center is able to instruct device 50 reading a carrier medium as to how the optical detectors should be optimally set in regard to the given arrangement of biological and/or chemical substances A through I. If necessary, testing can be repeated on carrier medium 30 using the optimized optical detectors.

In a second method, device 50 first reads code 32 of carrier medium 30 and sends this to the administrative center. The administrative center determines the associated arrangement of biological and/or chemical substances A through I and instructs device 50 as to how the optical detectors for this carrier medium 30 should be optimally set. Device 50 then performs the read procedure and detects the color signals emitted by defined regions 31. These are subsequently sent to the administrative center which determines whether, and if so which, of biological and/or chemical substances A through I have reacted with the analyte.

On carrier medium 30, information is provided within code 32 about the expiration date of carrier medium 30, which information is, for example, present as a supplementary six-digit code number attached to the seven-digit code number 32 containing the information about the arrangement of biological and/or chemical substances A through I within defined regions 31. Device 50 reads this code and issues a warning if the expiration date has already been passed.

In addition, device 50 reads the information from temperature sensor 37 and issues a possible warning in the event the specified maximum or minimum temperature has been exceeded at any time while carrier medium 30 was being stored.

Transmission of the data from device 50 to the administrative center proceeds after the data has been encrypted using a public key. This key is provided by the administrative center, and thus only the administrative center is able to decrypt the data. In addition, transmission of the data is error-protection-coded so that any transmission errors may be immediately discovered and eliminated.

In order to finance the production of the carrier media and, specifically, the biological and/or chemical substances, while at the same time providing the most inexpensive possible medical screening test for any person, provision is made whereby the evaluation of the codes and determination of the associated arrangement of the carrier media is performed at no charge within the administrative center, and a fee is charged only in the event one of the biological and/or chemical substances has reacted with the analyte.

1. Carrier medium (10, 20, 30, 30′) for analyzing an analyte, to which biological and/or chemical substances (A through I) are applied in at least two defined regions (11, 21, 31, 31′), with a code (12, 32, 3′) showing which biological and/or chemical substance (A through I) is located in which of the defined regions (11, 21, 31, 31′).

2. Carrier medium according to claim 1, characterized in that several hundred biological and/or chemical substances (A through I) are applied in the corresponding number of defined regions (11, 21, 31, 31′).

3. Carrier medium of claim 1, characterized in that the biological and/or chemical substances (A through I) are disposed differently in the defined regions (11, 21, 31, 31′).

4. Carrier medium according to claim 1, characterized in that the defined regions (11, 21, 31, 31′) are disposed differently on two different carrier media.

5. Carrier medium according to claim 1, characterized in that a temperature sensor (17, 37) is provided on carrier medium (10, 20, 30, 30′).

6. Carrier medium according to claim 1, characterized in that the code (12, 32, 32′) is a bar code, a numeric code, or an alphanumeric code or the code (12, 32, 32′) is given by the arrangement of the defined regions (21) on carrier medium (20).

7. Carrier medium according to claim 1, characterized in that the code (12, 32, 32′) provides information for a device (50) reading the carrier medium (10, 20, 30, 30′) as to how the device (50) should read which defined region (11, 21, 31, 31′).

8. Carrier medium according to claim 1, characterized in that the code (12, 32, 32′) contains information on the expiration date of the carrier medium (10, 20, 30, 30′).

9. Carrier medium according to claim 1, characterized in that the code (12, 32, 32′) contains information on the storage of carrier medium (10, 20, 30, 30′) from the time carrier medium (10, 20, 30, 30′) is manufactured until the time it is used.

10. Carrier medium according to claim 1, characterized in that the carrier medium (10, 20, 30, 30′) consists of a film, a glass carrier, or a paper.

11. Carrier medium according to claim 1, characterized in that DNA, RNA, proteins or antibodies are used as the biological and/or chemical substances (A through I).

12. Method for manufacturing a carrier media comprising:
a. producing a set of identical carrier media (30) having a first arrangement of the defined regions (31) and/or a first arrangement of biological and/or chemical substances within the defined regions (31),
b. assigning a different code (32) to each of these carrier media (30),
c. storing the arrangement of the defined regions (31) and/or the arrangement of the biological and/or chemical substances within the defined regions (31) of the carrier media (30) along with the associated code (32),
d. selecting a second arrangement of the defined regions (31), and/or of the biological and/or chemical substances in the defined regions (31), that is different from the first arrangement,
e. implementing steps a through c for the second arrangement,
f. implementing steps a through c for subsequent arrangements different from the arrangements already used.

13. Method according to claim 12, characterized in that the code (12, 32, 32′) represents a simple numbering of carrier medium (10, 30, 30′).

14. Method according to claim 12, characterized in that the biological and/or chemical substances (A through I) are printed with a print head analogous to that used in an ink jet printing process on the defined regions (11, 21, 31, 31′) of carrier medium (10, 20, 30, 30′).

15. Method according to claim 12, characterized in that a set consists of approximately 1,000 to 10,000 carrier media (30, 30′).

16. Method according to claim 12, characterized in that several hundred sets are manufactured.

17. Method according to claim 12, characterized in that one carrier medium each is selected from different sets and these selected carrier media are packed together.

18. Method according to claim 12, characterized in that several sets of carrier media are mixed and the carrier media are randomly selected for inclusion in a common pack.

19. Device for reading a carrier medium with at least one optical detector per defined region (31) on the carrier medium (30), wherein the optical detectors detect the reactions of biological and/or chemical substances in the defined regions (31) on the analyte as signals as soon as the carrier medium (30) has been brought into a read position relative to device (50).

20. Device according to claim 19, characterized in that means for acquiring and transmitting the code (32) to a an administrative center are provided.

21. Device according to claim 19, characterized in that the optical detector is a semiconductor chip.

22. Device according to claims 19, characterized in that means for digitizing the detected signals are provided.

23. Device according to claim 19, characterized in that means for transmitting the detected signals to the administrative center are provided.

24. Method for reading a carrier medium comprising:
a. applying the analyte to the carrier medium (30),
b. moving the carrier medium (30) into the read position relative to the device (50) for reading the carrier medium (30),
c. transmitting the code (32) of the carrier medium (30) to an administrative center,
d. within the administrative center, evaluating the code (32) and determining the associated arrangement.

25. Method according to claim 24, characterized in that evaluation of the code (32) and determination of the associated arrangement within the administrative center are performed by the administrative center at no cost and a fee is charged only if an analyte has reacted positively to one of the biological and/or chemical substances (A through D).

26. Method according to claim 24, characterized in that instructions are transmitted from the administrative center to the reading device (50) as to how the optical detectors are to be set for the individual defined regions (31).

27. Method according to claim 24, characterized in that as step e the reactions of the defined regions (31) are detected with the optimally set optical detectors.

28. Method according to claim 27, characterized in that the detected signals are transmitted to the administrative center as step f.

29. Method according to claim 28, characterized in that, as step g, the arrangement of the biological and/or chemical substances (A to I) of the carrier medium (30) and/or the evaluation of the detected signals is/are transmitted from the administrative center to the device (50) for reading.

30. Method according to claim 24, characterized in that, according to step b first the reactions of the defined regions (31) are detected with the optical detectors of device (50) and in step c additionally the detected signals are transmitted to the administrative center.

31. Method according to claim 30, characterized in that, as step e, the arrangement of the biological and/or chemical substances (A through I) of the carrier medium (30) and/or the evaluation of the detected signals are transmitted from the administrative center to the device (50).

32. Method according to claim 24, characterized in that instructions are transmitted by the administrative center to reset certain defined regions (31) according to the detected signals.

33. Method according to claim 24, characterized in that the request is sent by the administrative center, in response to certain detected signals, to read another carrier medium having biological and/or chemical substances different from the biological and/or chemical substances on the first carrier medium after application of the analyte.

34. Method according to claim 24, characterized in that the detected signals and the code (32) for transmittal from the device (50) to the administrative center is keyed with a public key.

35. Method according to claim 24, characterized in that the transmission of the detected signals and the code (32) to the administrative center is error-protection-coded.
